(19) United States
(12) Patent Application Publication
(10) Pub. No.: US 2025/0144475 A1
(43) Pub. Date: May 8, 2025

(54) PNEUMATIC SYNCHRONOUS LIFTING STILT DEVICE

(71) Applicant: Dongguan City GeShengMei Industrial Co., Ltd, Dongguan (CN)

(72) Inventor: Taotao Lei, Dongguan (CN)

(21) Appl. No.: 19/015,848

(22) Filed: Jan. 10, 2025

(30) Foreign Application Priority Data
Nov. 15, 2024 (CN) 202422796389.7

(51) Int. Cl. A63B 25/00; F15B 13/04; F15B 15/14; F15B 20/00

(52) U.S. Cl. CPC A63B 25/00; F15B 13/0401; F15B 15/1428; F15B 20/00; A63B 2225/093

(57) ABSTRACT

A pneumatic synchronous lifting stilt device includes a pneumatic driving assembly, a left stilt assembly and a right stilt assembly. The stilt assembly includes a fixed frame, a lifting platform assembly, and a cylinder body, the lifting platform assembly is mounted on the cylinder body, the fixed frame is provided with an inner rod, the cylinder body is sleeved over the inner rod, and the pneumatic driving assembly is configured outside the cylinder body. The fixed frame includes a connecting platform and a supporting platform, the connecting platform is located on one side of the supporting platform, a lower end of the inner rod is connected to the connecting platform; and the supporting platform is located directly below the lifting platform assembly. The stilt device achieves synchronous adjustment, has a simple structure, and is balanced in force, comfortable and safe to use.

### CROSS REFERENCE TO RELATED APPLICATIONS

The present application claims the benefit of Chinese Patent Application No. 2024227963897 filed on Nov. 15, 2024, the contents of which are incorporated herein by reference in their entirety.

### FIELD OF THE INVENTION

The present invention relates to the field of lifting stilt device technology, particularly to a pneumatic synchronous lifting stilt device.

### BACKGROUND OF THE INVENTION

Stilts can be used in indoor decoration, outdoor construction, orchard harvesting, etc. Currently, there are flexible stilts with adjustable length on the market. The legs of the conventional stilts are generally adjusted individually, that is, one leg is used as support to adjust the other leg, and then the other leg is used as support to adjust the stilt on one leg. This method requires multiple adjustments repeatedly. However, multiple adjustments bring danger to the user who stands thereon. Additionally, since the lifting platform that supports the feet on the existing stilts is located on the inner side of the support rod of the stilt, and the support point between the supporting rod and the ground is offset from the force point of the lifting platform by a certain distance, therefore, when a user stands on the lifting platform, the stilts are subjected to two unbalanced forces of gravity and ground support, which produce a torque. This causes the upper end of the stilt device to press towards the body, making it very uncomfortable and unsafe to use. Thus, the existing stilt device cannot meet the requirements.

Therefore, there is an urgent need for a pneumatic synchronous lifting stilt device to solve the above problems.

### SUMMARY OF THE INVENTION

A purpose of the present invention is to provide a pneumatic synchronous lifting stilt device which achieves synchronous adjustment, has a simple structure, and is balanced in force, comfortable and safe to use.

In order to achieve the purpose mentioned above, the present invention provides a pneumatic synchronous lifting stilt device including a pneumatic driving assembly, a left stilt assembly and a right stilt assembly symmetrically arranged. Each of the left and right stilt assemblies includes a fixed frame, a lifting platform assembly, and a cylinder body, the lifting platform assembly is mounted on the cylinder body, the fixed frame is provided with an inner rod, the cylinder body is sleeved over the inner rod and slidable relatively to the inner rod, the pneumatic driving assembly is configured outside the cylinder body of one of the left and right stilt assemblies and drives the sliding between the cylinder body and the inner rod, thereby lifting or lowering the lifting platform assembly. The lifting platform assembly is located on one side of the cylinder body that is closer to the other cylinder body. The fixed frame includes a connecting platform and a supporting platform, the connecting platform is located on one side of the supporting platform, a lower end of the inner rod is connected to the connecting platform; and the supporting platform is located on the side of the cylinder body that is closer to the other cylinder body, and is directly below the lifting platform assembly on that side.

Preferably, the pneumatic driving assembly includes a first air valve, an air intake pipe, and a first air hose, the first air valve is installed outside the cylinder body, the air intake pipe is connected to the first air valve, one end of the first air hose is connected to the first air valve, a middle part of the first air hose is connected to the cylinder body of the right stilt assembly, and the other end of the first air hose is connected to the cylinder body of the left stilt assembly, by air intake through the air intake pipe and an opening of the first air valve, the cylinder body is full with air, driving the lifting platform assembly to lift up.

Preferably, the pneumatic synchronous lifting stilt device further includes a protective assembly for locking a relative position between the inner rod and the cylinder body.

Preferably, the protective assembly includes a pneumatic pressure head, an engaging rod, a second air valve, and a second air hose, the second air valve is installed outside the cylinder body, the air intake pipe is connected to the second air valve, one end of the second air hose is connected to the second air valve, the other end of the second air hose is connected to the pneumatic pressure head, a lower end of the engaging rod is connected to the connecting platform, the engaging rod is provided with engaging teeth arranged along a length thereof, the pneumatic pressure head is provided with an engaging block that matches the engaging teeth, by air intake through the air intake pipe and an opening of the second air valve, air in the second air hose pushes the engaging block of the pneumatic pressure head to move away from a direction of the engaging rod, keeping the engaging teeth and the engaging block in a disengaged state.

Preferably, the engaging rod is coaxial with the inner rod, and is integrally connected with the inner rod.

Preferably, the lifting platform assembly includes a lower connecting member and a foot fixing member, the foot fixing member is connected to the cylinder body through the lower connecting member; the foot fixing member is located on the side of the cylinder body that is closer to the other cylinder body, and is directly above the supporting platform on that side.

Preferably, the lifting platform assembly further includes an upper connecting member and a leg fixing member, the leg fixing member is connected to the cylinder body through the upper connecting member; the leg fixing member is located on the side of the cylinder body that is closer to the other cylinder body, and is directly above the foot fixing member on that side.

Preferably, the fixed frame further includes a supporting base and a first spring member, the supporting platform is pivoted to the supporting base, one end of the first spring member is pivoted to one side of the supporting platform, and the other end of the first spring member is pivoted to one side of the supporting base.

Preferably, the first air valve is configured with a first flow regulator for regulating an air flow rate.

Preferably, the second air valve is configured with a second flow regulator for regulating an air flow rate.

Compared with the prior art, the present stilt device includes the pneumatic driving assembly, the left stilt assembly, and the right stilt assembly; the stilt assembly includes a fixed frame, a lifting platform assembly, and a cylinder body, with the lifting platform assembly mounted on the cylinder body, and the fixed frame having an inner rod. Further, the cylinder body is sleeved over the inner rod and can slide relative to the inner rod, and the relative sliding between the cylinder body and the inner rod drives the lifting platform assemblies to lift or lower simultaneously. This not only has a simple structure and low cost but also avoids the defect of traditional stilt device requiring multiple adjustments on the left and right sides, thereby improving the convenience and safety of use. Furthermore, the lifting platform assembly is arranged on the side of the cylinder body close to the other cylinder body, and the supporting platform is arranged on the side of the cylinder body close to the other cylinder body, and directly below the lifting platform assembly on that side, thus it's ensured that the force of gravity on the lifting platform assembly and the supporting force on the supporting platform are on the same straight line, which will not produce a torque. This makes the left stilt assembly and the right stilt assembly self-balanced in force, thereby preventing the upper end of the stilt device from pressing towards the body, and enhancing the comfort and safety of use.

### BRIEF DESCRIPTION OF THE DRAWINGS

FIG. 1 is a perspective view of the pneumatic synchronous lifting stilt device according to an embodiment of the present invention.

FIG. 2 is another perspective view of the pneumatic synchronous lifting stilt device according to the present invention.

FIG. 3 is a front view of the pneumatic synchronous lifting stilt device according to the present invention.

FIG. 4 is a side view of the pneumatic synchronous lifting stilt device according to the present invention.

FIG. 5 is a partial enlarged view of part A in FIG. 4.

FIG. 6 is a structural view of the pneumatic synchronous lifting stilt device according to another embodiment of the present invention.

### DETAILED DESCRIPTION OF ILLUSTRATED EMBODIMENTS

To provide a detailed explanation of the technical content, and structural features of the present invention, the following is further explained in conjunction with the implementation method and the accompanying drawings.

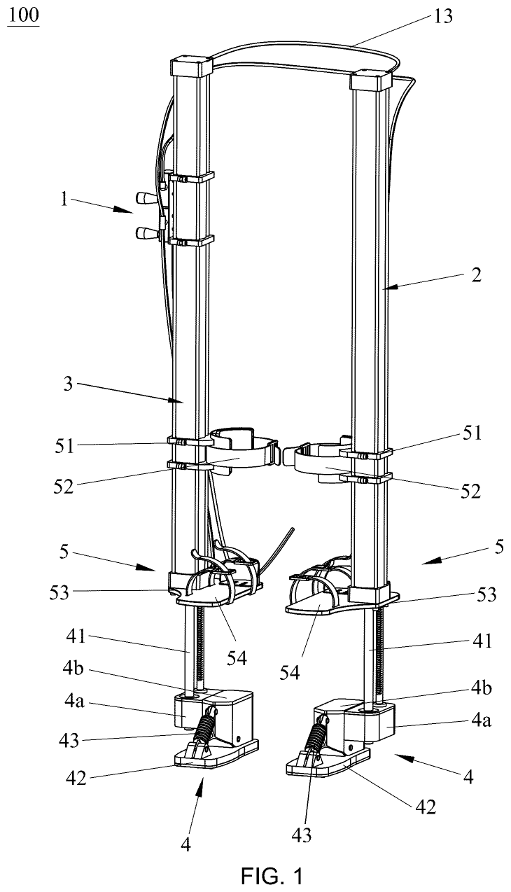

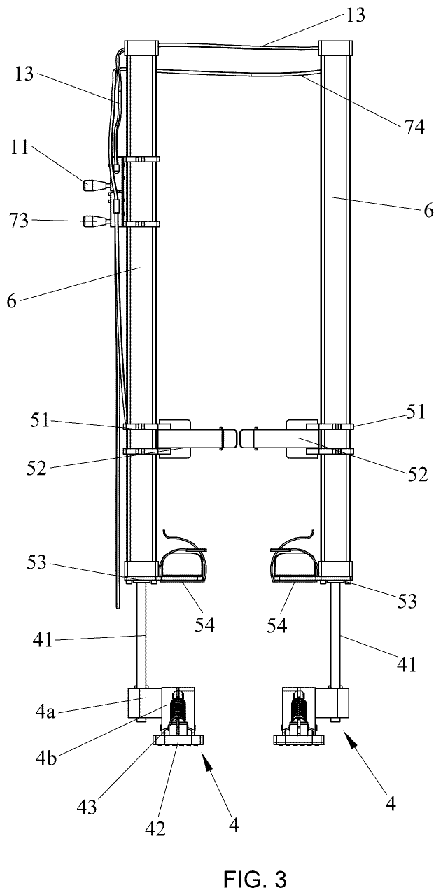

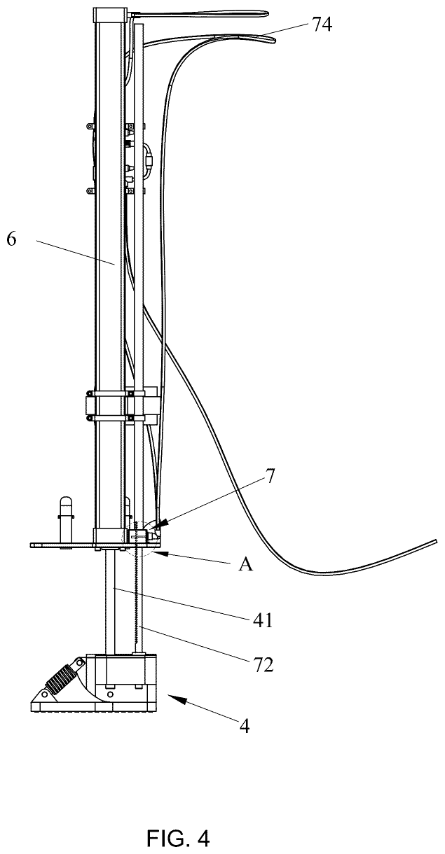

Referring to FIGS. 1 to 4, the pneumatic synchronous lifting stilt device 100 of the present invention includes a pneumatic driving assembly 1, a left stilt assembly 2, and a right stilt assembly 3. The left stilt assembly 2 and the right stilt assembly 3 are symmetrically arranged. Each of the left and right stilt assemblies 2 and 3 includes a fixed frame 4, a lifting platform assembly 5, and a cylinder body 6. The lifting platform assembly 5 is mounted on the cylinder body 6, and the lifting and lowering of the cylinder body 6 can drive the lifting and lowering of the lifting platform assembly 5. The fixed frame 4 has an inner rod 41, and the cylinder body 6 is sleeved over the inner rod 41 and can slide up and down relative to the inner rod 41. The cylinder body 6 has a chamber, and the cylinder body 6 and the inner rod 41 together form a telescopic cylinder. The relative sliding between the cylinder body 6 and the inner rod 41 drives the lifting platform assembly 5 to lift and lower. The pneumatic driving assembly 1 includes a first air valve 11, an air intake pipe 12, and a first air hose 13. The first air valve 11 is installed outside the cylinder body 6, the air intake pipe 12 is connected to the first air valve 11, one end of the first air hose 13 is connected to the first air valve 11, a middle part of the first air hose 13 is connected to the cylinder body 6 of the right stilt assembly 3, and the other end of the first air hose 13 is connected to the cylinder body 6 of the left stilt assembly 2. By the air intake through the air intake pipe 12 and the opening of the first air valve 11, the two cylinder bodies 6 are inflated, causing the lifting platform assemblies 5 on both sides to lift. In other words, since the air intake pipe 12 controls the inflation inside the cylinder bodies 6 of both the left stilt assembly 2 and the right stilt assembly 3 simultaneously, the air intake through the air intake pipe 12 and the operation of the first air valve 11 can achieve synchronous lifting on both sides. The height of the stilt assemblies can be locked once the first air valve 11 is turned off. Conversely the height of the stilt assemblies can be lowered once the first air valve 11 is turned on to release the air. By this token, this not only has a simple structure and low cost but also avoids the defect of traditional stilt device requiring multiple adjustments on the left and right sides, thereby improving the convenience and safety of use.

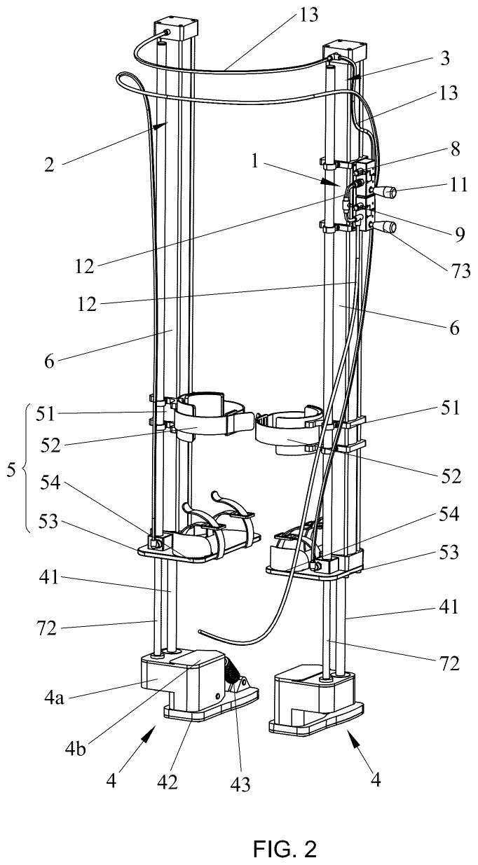

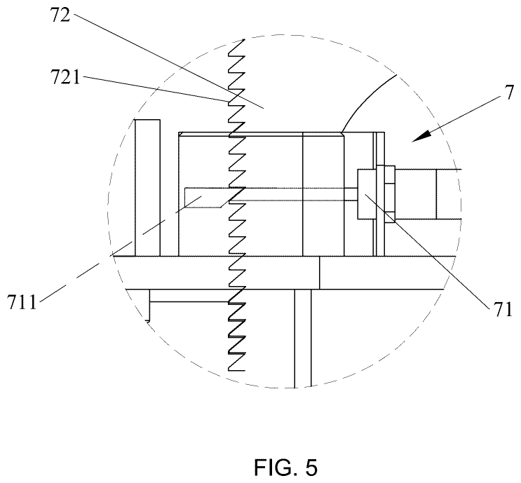

More specifically, referring to FIGS. 2 to 5, the pneumatic synchronous lifting stilt device 100 of the present invention further includes a protective assembly 7 for locking the relative position between the inner rod 41 and the cylinder body 6. For example, the protective assembly 7 includes a pneumatic pressure head 71, an engaging rod 72, a second air valve 73, and a second air hose 74. The second air valve 73 is installed outside the cylinder body 6, the air intake pipe 12 is connected to the second air valve 73, one end of the second air hose 74 is connected to the second air valve 73, and the other end of the second air hose 74 is connected to the pneumatic pressure head 71. The engaging rod 72 is located on one side of the inner rod 41 and its lower end is connected to the connecting platform 4a of the fixed frame 4. The engaging rod 72 has engaging teeth 721 arranged along its length. The pneumatic pressure head 71 is set on the cylinder body 6 or the lifting platform assembly 5 and has an engaging block 711 that cooperates with the engaging teeth 721. By the air intake through the air intake pipe 12 and the opening of the second air valve 73, the air in the second air hose 74 pushes the engaging block 711 of the pneumatic pressure head 71 to move away from the direction of the engaging rod 72 and keeps the engaging teeth 721 and the engaging block 711 in a disengaged state. The engaging block 711 of the pneumatic pressure head 71 moves towards the direction of the engaging rod 72, and the engaging teeth 721 and the engaging block 711 are maintained in an engaged state.

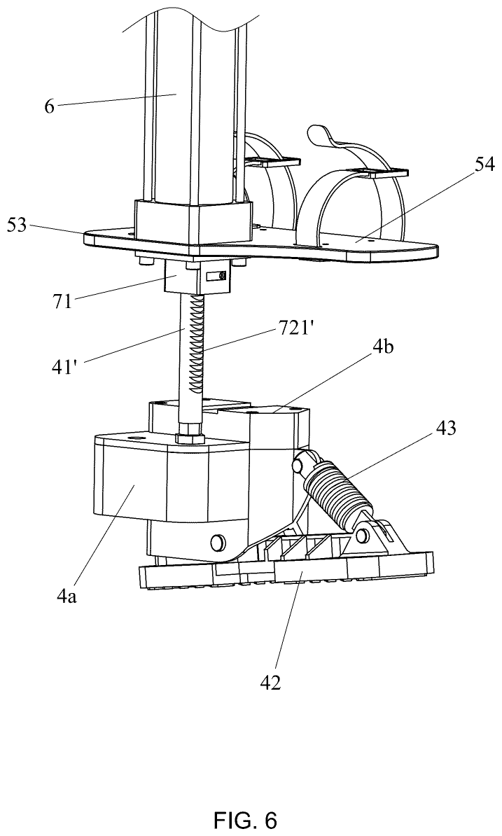

In another preferred embodiment, as shown in FIG. 6, the engaging rod and the inner rod 41′ are coaxial and formed in an integral unity, that is, the engaging teeth 721′ of the engaging rod are arranged on the inner rod 41′, which can also achieve the same technical effect and makes the structure simpler.

Referring to FIGS. 1 to 5, the lifting platform assembly 5 includes an upper connecting member 51, a leg fixing member 52, a lower connecting member 53, and a foot fixing member 54. The leg fixing member 52 is connected to the cylinder body 6 through the upper connecting member 51, and the foot fixing member 54 is connected to the cylinder body 6 through the lower connecting member 53. The upper connecting member 51 and the leg fixing member 52 are integrally formed. The lower connecting member 53 and the base plate of the foot fixing member 54 are integrally formed. In this embodiment, the lifting platform assembly 5 is located on one side of the cylinder body 6 close to the other cylinder body. The lower connecting member 53 is fixed to the cylinder body 6. The foot fixing member 54 is located on one side of the cylinder body 6 close to the other cylinder body. The fixed frame 4 includes a connecting platform 4a and a supporting platform 4b, the connecting platform 4a is located on one side of the supporting platform 4b, and the lower end of the inner rod 41 is connected to the connecting platform 4a. The supporting platform 4b is located on the side of the cylinder body 6 close to the other cylinder body and is directly below the foot fixing member 54 on that side. In such configurations, the foot fixing member 54 can be supported on the supporting platform 4b when the lifting platform assembly 5 is lowered to the lowest position, thus facilitating the user to get on and off. Furthermore, it's ensured that the lifting platform assembly 5 subjected to the user's gravity and the supporting platform 4b subjected to the ground's supporting force can be located on the same vertical straight line, making the left stilt assembly 2 and the right stilt assembly 3 self-balanced in force, which will not generate a torque on the stilt device. The leg fixing member 52 is located on the side of the cylinder body 6 close to the other cylinder body and is directly above the foot fixing member 54 on that side. Both the foot fixing member 54 and the leg fixing member 52 are provided with straps or bands to connect the user's body.

Referring to FIGS. 1 to 5, the fixed frame 4 further includes a supporting base 42 and a first spring member 43. The supporting platform 4b is pivoted to the supporting base 42, one end of the first spring member 43 is pivoted to one side of the supporting platform 4b, and the other end of the first spring member 43 is pivoted to one side of the supporting base 42. The buffering of the spring member makes the forward and backward movements of the lifting platform assembly 5 more stable.

Referring to FIGS. 1 to 5, the first air valve 11 is configured with a first flow regulator 8 for adjusting the air flow rate, which allows the user to adjust the lifting or lowering rate as needed. The second air valve 73 is configured with a second flow regulator 9 for adjusting the air flow rate, which allows the user to adjust the rate of air intake and air release of the second air valve 73 according to actual needs. Of course, the manufacturer can remove the first flow regulator 8 or the second flow regulator 9 according to actual needs.

Referring to FIGS. 1 to 5, the working process of the pneumatic synchronous lifting stilt device 100 of the present invention follows.

First, after the external air compressor operates, the free end of the air intake pipe 12 is inserted into the air outlet of the air compressor. The person stands on the lower connecting member 53 and secures his/her body using the foot fixing member 54 and the leg fixing member 52.

For the lifting operation, the switch of the first air valve 11 is operated to allow high-pressure air to enter the cylinder body 6. The inner rod 41 is extended relative to the cylinder body 6, and the leg fixing member 52 and the foot fixing member 54 begin to lift. Concurrently, as the air intake pipe 12 takes in air, the opening of the second air valve 73 allows the air in the second air hose 74 to push the engaging block 711 of the pneumatic pressure head 71 away from the direction of the engaging rod 72, thereby keeping the engaging teeth 721 in a disengaged state with the engaging block 711. The second air valve 73 is a one-way valve, and the self-locking cylinder formed at the pneumatic pressure head 71 automatically closes after being full with air.

When the desired height is reached, the switch of the first air valve 11 is operated to close the air intake to the cylinder body 6. Then, the second air valve 73 is operated to exhaust the self-locking cylinder body 6, then the engaging block 711 of the pneumatic pressure head 71 moves towards the direction of the engaging rod 72, keeping the engaging teeth 721 in an engaged state with the engaging block 711, thereby achieving locking.

For the lowering operation, the switch of the first air valve 11 is operated to release the air from the cylinder body 6, causing the stilt device to begin lowering. Once the desired height is reached, the first air valve 11 is turned off and stops venting, and the stilt device will be stopped at the current height.

If the lifting or lowering speed is too fast, the flow control knob of the first flow regulator 8 is adjusted to regulate the speed to a suitable level.

The present stilt device includes the pneumatic driving assembly 1, the left stilt assembly 2, and the right stilt assembly 3, the stilt assembly includes a fixed frame 4, a lifting platform assembly 5, and a cylinder body 6, with the lifting platform assembly 5 mounted on the cylinder body 6, and the fixed frame 4 having an inner rod 41. Further, the cylinder body 6 is sleeved over the inner rod 41 and can slide relative to the inner rod 41, and the relative sliding between the cylinder body 6 and the inner rod 41 drives the lifting platform assembly 5 to lift or lower. The pneumatic driving assembly 1 includes a first air valve 11, an air intake pipe 12, and a first air hose 13. The first air valve 11 is installed outside the cylinder body 6, connected to the air intake pipe 12, with one end of the first air hose 13 connected to the first air valve 11, the middle part of the first air hose 13 connected to the cylinder body 6 of the right stilt assembly 3, and the other end of the first air hose 13 connected to the cylinder body 6 of the left stilt assembly 2. By the air intake through the air intake pipe 12 and the opening of the first air valve 11, both cylinder bodies 6 are full with air, driving the lifting platform assemblies 5 on both sides to lift. In other words, since the air intake pipe 12 controls the cylinder bodies 6 of both the left stilt assembly 2 and the right stilt assembly 3 simultaneously, the air intake through the air intake pipe 12 and the operation of the first air valve 11 can achieve synchronous lifting on both sides. The height of the stilt assembly can be locked if the first air valve 11 is turned off. When it is necessary to lower the stilt, the first air valve 11 is turned on again to release the air. This not only has a simple structure and low cost but also avoids the defect of traditional stilt device requiring multiple adjustments on the left and right sides, thereby improving the convenience and safety of use. Furthermore, the lifting platform assembly 5 is arranged on the side of the cylinder body 6 close to the other cylinder body, and the supporting platform 4b is arranged on the side of the cylinder body 6 close to the other cylinder body, and directly below the lifting platform assembly 5 on that side, thus it's ensured that the force of gravity on the lifting platform assembly 5 and the supporting force on the supporting platform 4b are on the same straight line, which will not produce a torque. This makes the left stilt assembly 2 and the right stilt assembly 3 self-balanced in force, thereby preventing the upper end of the stilt device from pressing towards the body, and enhancing the comfort and safety of use.

The above disclosure is only a preferred example of the present invention and cannot be used to limit the scope of rights of the present invention. Therefore, any equivalent changes made in accordance with the claims of the present invention are within the scope of the present invention.

What is claimed is:

1. A pneumatic synchronous lifting stilt device, comprising a pneumatic driving assembly, a left stilt assembly and a right stilt assembly symmetrically arranged, wherein each of the left and right stilt assemblies comprises a fixed frame, a lifting platform assembly, and a cylinder body, the lifting platform assembly is mounted on the cylinder body, the fixed frame is provided with an inner rod, the cylinder body is sleeved over the inner rod and slidable relatively to the inner rod, the pneumatic driving assembly is configured outside the cylinder body of one of the left and right stilt assemblies and drives the sliding between the cylinder body and the inner rod, thereby lifting or lowering the lifting platform assembly; the lifting platform assembly is located on one side of the cylinder body that is closer to the other cylinder body; the fixed frame comprises a connecting platform and a supporting platform, the connecting platform is located on one side of the supporting platform, a lower end of the inner rod is connected to the connecting platform; and the supporting platform is located on the side of the cylinder body that is closer to the other cylinder body, and is directly below the lifting platform assembly on that side.

2. The pneumatic synchronous lifting stilt device according to claim 1, wherein the pneumatic driving assembly comprises a first air valve, an air intake pipe, and a first air hose, the first air valve is installed outside the cylinder body, the air intake pipe is connected to the first air valve, one end of the first air hose is connected to the first air valve, a middle part of the first air hose is connected to the cylinder body of the right stilt assembly, and the other end of the first air hose is connected to the cylinder body of the left stilt assembly, by air intake through the air intake pipe and an opening of the first air valve, the cylinder body is full with air, driving the lifting platform assembly to lift up.

3. The pneumatic synchronous lifting stilt device according to claim 1, further comprising a protective assembly for locking a relative position between the inner rod and the cylinder body.

4. The pneumatic synchronous lifting stilt device according to claim 3, wherein the protective assembly comprises a pneumatic pressure head, an engaging rod, a second air valve, and a second air hose, the second air valve is installed outside the cylinder body, the air intake pipe is connected to the second air valve, one end of the second air hose is connected to the second air valve, the other end of the second air hose is connected to the pneumatic pressure head, a lower end of the engaging rod is connected to the connecting platform, the engaging rod is provided with engaging teeth arranged along a length thereof, the pneumatic pressure head is provided with an engaging block that matches the engaging teeth, by air intake through the air intake pipe and an opening of the second air valve, air in the second air hose pushes the engaging block of the pneumatic pressure head to move away from a direction of the engaging rod, keeping the engaging teeth and the engaging block in a disengaged state.

5. The pneumatic synchronous lifting stilt device according to claim 4, wherein the engaging rod is coaxial with the inner rod, and is integrally connected with the inner rod.

6. The pneumatic synchronous lifting stilt device according to claim 1, wherein the lifting platform assembly comprises a lower connecting member and a foot fixing member, the foot fixing member is connected to the cylinder body through the lower connecting member; the foot fixing member is located on the side of the cylinder body that is closer to the other cylinder body, and is directly above the supporting platform on that side.

7. The pneumatic synchronous lifting stilt device according to claim 6, wherein the lifting platform assembly further comprises an upper connecting member and a leg fixing member, the leg fixing member is connected to the cylinder body through the upper connecting member; the leg fixing member is located on the side of the cylinder body that is closer to the other cylinder body, and is directly above the foot fixing member on that side.

8. The pneumatic synchronous lifting stilt device according to claim 1, wherein the fixed frame further comprises a supporting base and a first spring member, the supporting platform is pivoted to the supporting base, one end of the first spring member is pivoted to one side of the supporting platform, and the other end of the first spring member is pivoted to one side of the supporting base.

9. The pneumatic synchronous lifting stilt device according to claim 2, wherein the first air valve is configured with a first flow regulator for regulating an air flow rate.

10. The pneumatic synchronous lifting stilt device according to claim 4, wherein the second air valve is configured with a second flow regulator for regulating an air flow rate.
